(19) United States
(12) Patent Application Publication
(10) Pub. No.: US 2026/0288151 A1
(43) Pub. Date: Sep. 24, 2026

(54) INFORMATION PROCESSING METHOD, INFORMATION PROCESSING APPARATUS, AND PROGRAM

(71) Applicant: SONY GROUP CORPORATION, TOKYO (JP)

(72) Inventors: KURENA MOTOKURA, KANAGAWA (JP); ATSUSHI IZUMIHARA, KANAGAWA (JP); NAOKI UCHIDA, KANAGAWA (JP); YOSHIAKI NAKAJIMA, KANAGAWA (JP); PRAKASH ISHWAR HEBBAR, KANAGAWA (JP)

(21) Appl. No.: 19/479,751

(22) PCT Filed: Apr. 22, 2024
(86) PCT No.: PCT/JP2024/015670

§ 371 Date: Oct. 29, 2025

(30) Foreign Application Priority Data
May 8, 2023 (JP) 2023-076541

(51) Int. Cl. G05D 1/622; G05D 1/648; G06V 20/58

(52) U.S. Cl. CPC G05D 1/622; G05D 1/648; G06V 20/58

(57) ABSTRACT

The present technology relates to an information processing method, an information processing apparatus, and a program capable of performing route planning more easily. The information processing apparatus includes an information processing unit that calculates, on the basis of a position of one or more subjects in a task space, an imageable region where a robot that images the subject is capable of imaging the subject in a configuration space of the robot, and displays an image of the configuration space in which the imageable region is displayed. The present technology can be applied to an information processing system.

### TECHNICAL FIELD

The present technology relates to an information processing method, an information processing apparatus, and a program, and more particularly, to an information processing method, an information processing apparatus, and a program which enable route planning to be performed more easily.

### BACKGROUND ART

In the related art, various technologies related to route planning for robots have been proposed. For example, as such a technology, a technology has been proposed which obtains a route at high speed even for a multi-joint manipulator with a high degree of freedom by generating a sub-goal directed graph on the basis of interference check results of geometric models of the robot and the work environment, and evaluation of distances between sub-goals (for example, refer to Patent Document 1).

### CITATION LIST

### Patent Document

Patent Document 1: Japanese Patent Application Laid-Open No. 2000-20117

### SUMMARY OF THE INVENTION

### Problems to be Solved by the Invention

By the way, in planning a travel route of a robot that images a predetermined subject, it is not easy to perform appropriate route planning due to various conditions, such as avoiding the inclusion of obstacles in an image during the imaging and smoothly switching between subjects as much as possible.

The present technology has been made in view of such circumstances, and enables route planning to be performed more easily.

### Solutions to Problems

An information processing method or program according to one aspect of the present technology includes a step of calculating, on the basis of a position of one or more subjects in a task space, an imageable region where a robot that images the subject is capable of imaging the subject in a configuration space of the robot; and a step of displaying an image of the configuration space in which the imageable region is displayed.

An information processing apparatus according to one aspect of the present technology includes an information processing unit that calculates, on the basis of a position of one or more subjects in a task space, an imageable region where a robot that images the subject is capable of imaging the subject in a configuration space of the robot, and displays an image of the configuration space in which the imageable region is displayed.

In one aspect of the present technology, on the basis of a position of one or more subjects in a task space, an imageable region where a robot that images the subject is capable of imaging the subject in a configuration space of the robot is calculated, and an image of the configuration space in which the imageable region is displayed is displayed.

### BRIEF DESCRIPTION OF DRAWINGS

FIG. 1 is a diagram illustrating a configuration example of an information processing system.

FIG. 2 is a diagram describing a task space.

FIG. 3 is a diagram describing mapping to a configuration space.

FIG. 4 is a diagram illustrating an example of a display screen.

FIG. 5 is a flowchart describing map generation processing and a preliminary preparation processing.

FIG. 6 is a flowchart describing travel preparation processing and travel processing.

FIG. 7 is a flowchart describing travel preparation processing and travel processing.

FIG. 8 is a diagram illustrating a configuration example of a computer.

### MODE FOR CARRYING OUT THE INVENTION

Hereinafter, embodiments to which the present technology is applied will be described with reference to the drawings.

### FIRST EMBODIMENT

### Configuration Example of Information Processing System

The present technology can be applied to an information processing system that plans a travel route of a robot having an imaging function when the robot images one or a plurality of subjects. In the information processing system of the present technology, by mapping a region in which a subject can be imaged to a configuration space, route planning can be performed more easily.

For example, as an example of the imaging by the robot, a case of imaging a performance by a plurality of dancers is considered.

During the imaging, there may be cases where only one person is intended to be imaged as the subject, while in other cases, multiple people are intended to be imaged together. Furthermore, it is also desirable for the subjects to be switched as smoothly and intentionally as possible.

As a specific example, it is assumed that the subject is switched from a dancer A to a dancer B, or that a state where the dancer A is shown is switched to a state where both the dancer A and the dancer B are shown.

In a case where such imaging is performed by a robot, it is necessary, in planning the travel route of the robot, to determine whether or not, for example, following conditions a to c are satisfied.
Condition a: There is no obstacle between a subject and a robot.
Condition b: Intended multiple people can be imaged together.
Condition c: The subject can be switched as smoothly as possible.

For example, in a case where an operator decides a travel rail, that is, a travel route of the robot, it is difficult for the operator to determine whether or not the above conditions a to c are satisfied.

Furthermore, for example, even in a case where the robot autonomously plans the travel route and travels, it is necessary for the robot to autonomously determine (decide) a travel route satisfying the above conditions a to c, but making such a determination is difficult.

Therefore, in the present technology, by mapping information regarding a subject or an obstacle to a configuration space, it is possible to easily determine a travel route satisfying the above conditions a to c. That is, the route planning can be performed more easily.

For example, in the configuration space of a robot (mobile robot) that performs imaging, the position and posture of the robot can be treated as points. Note that, in the following, an example in which the configuration space of the robot is three-dimensional will be described.

In the present technology, on the configuration space of the robot, a region where a subject can be imaged, a subject or an obstacle present in an imaging environment, and the like are mapped.

Therefore, information required for route planning is visualized on the configuration space. Accordingly, for example, information necessary for route planning can be presented in an easily understandable manner to an operator (user) of the robot that performs the route planning.

Specifically, for example, by mapping a region where a subject can be imaged and the like, it is possible to easily determine which subject can be imaged from which position, and positions desired to be avoided or positions desired to pass through as a route are clearly defined as a three-dimensional space.

Therefore, by three-dimensionally planning the travel route of the robot on the configuration space in which a region where a subject can be imaged and the like are mapped, it becomes possible to easily obtain a route in which the inclusion of obstacles in the image is avoided and the subject is smoothly imaged as intended.

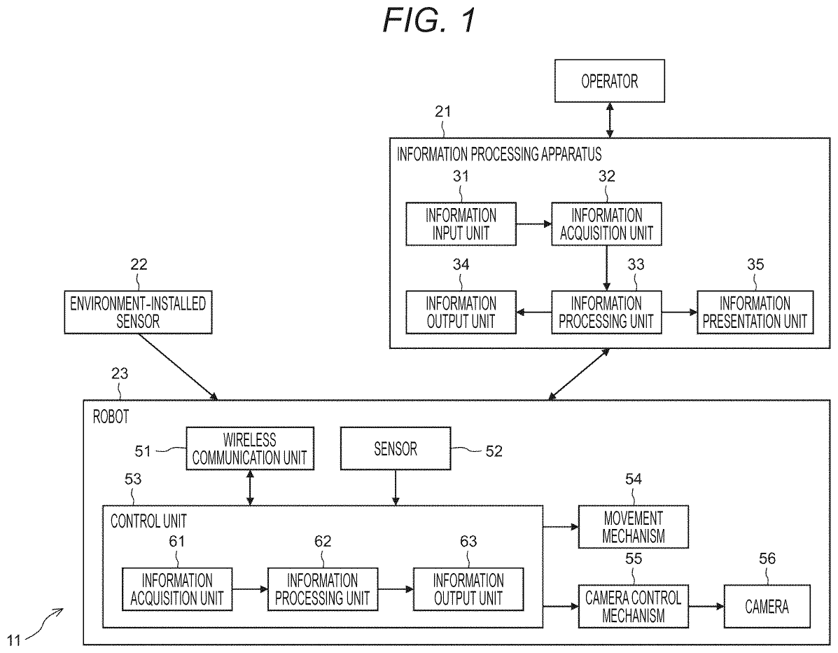

FIG. 1 is a diagram illustrating a configuration example of an embodiment of an information processing system to which the present technology is applied.

An information processing system 11 illustrated in FIG. 1 includes an information processing apparatus 21, an environment-installed sensor 22, and a robot 23.

In the information processing system 11, an image of the configuration space of the robot 23, in which information regarding subjects and obstacles is mapped, is displayed on the information processing apparatus 21 operated by the operator, and the travel route of the robot 23 is planned as appropriate.

Furthermore, the robot 23 having an imaging function is arranged in a space where a subject as an imaging target is present (hereinafter, referred to as a task space).

The robot 23 travels within the task space along the travel route obtained through the planning, while appropriately acquiring the output from the environment-installed sensor 22 arranged at a position within the task space or in the vicinity of the task space, and images the subject.

The information processing apparatus 21 includes, for example, a personal computer, a tablet terminal, or the like, and realizes an application regarding the travel route planning of the robot 23 by executing a program.

The information processing apparatus 21 includes an information input unit 31, an information acquisition unit 32, an information processing unit 33, an information output unit 34, and an information presentation unit 35.

The information input unit 31 includes, for example, input devices such as a mouse, a keyboard, and a touch panel, and supplies signals according to the operation by the operator to the information acquisition unit 32.

The information acquisition unit 32 includes, for example, a communication unit that performs communication with an external device, and acquires predetermined information by receiving the supply of the signal according to the operator's operation from the information input unit 31 and receiving information transmitted from the robot 23, and supplies the acquired information to the information processing unit 33.

The information processing unit 33 controls the entire operation of the information processing apparatus 21.

For example, the information processing unit 33 performs predetermined information processing on the basis of the information supplied from the information acquisition unit 32, and supplies an image obtained as a result of the information processing to the information presentation unit 35 to display the image, or supplies information and the like obtained through the information processing to the information output unit 34 to transmit the information and the like to the robot 23.

The information output unit 34 includes, for example, a communication unit that performs communication with an external device, and transmits various kinds of information supplied from the information processing unit 33 to the robot 23. The information presentation unit 35 includes, for example, a display, and displays an image supplied from the information processing unit 33.

The environment-installed sensor 22 includes, for example, an RGB camera, an RGB-D camera, a sensor using an Ultra Wide Band (UWB) method, or the like, detects the position of the subject on the task space, and transmits subject position information indicating the detection result to the robot 23

Note that, for ease of illustration, only one environment-installed sensor 22 is illustrated in the drawing, but it is also possible to provide a plurality of environment-installed sensors 22.

The robot 23 is a mobile robot that images a target subject while traveling within the task space.

The robot 23 includes a wireless communication unit 51, a sensor 52, a control unit 53, a movement mechanism 54, a camera control mechanism 55, and a camera 56.

The wireless communication unit 51 performs wireless communication with external devices such as the information processing apparatus 21 and the environment-installed sensor 22. For example, the wireless communication unit 51 receives information transmitted from the information processing apparatus 21 or the environment-installed sensor 22 and supplies the information to the control unit 53, or transmits information supplied from the control unit 53 to the information processing apparatus 21.

The sensor 52 includes various sensors such as 2D or 3D Light Detection And Ranging (LiDAR) and an RGB-D camera. The sensor 52 detects the position of the subject or the obstacle on the task space, and supplies the detection result to the control unit 53.

The control unit 53 includes a computer or the like that controls the overall operation of the robot 23. The control unit 53 includes an information acquisition unit 61, an information processing unit 62, and an information output unit 63.

The information acquisition unit 61 acquires various kinds of information by receiving the supply of the information from the wireless communication unit 51 or acquiring the detection result of the subject and the obstacle output from the sensor 52, and supplies the acquired information to the information processing unit 62.

The information processing unit 62 performs information processing on the basis of the information supplied from the information acquisition unit 61, and appropriately supplies various kinds of information obtained as a result thereof to the information output unit 63. Furthermore, for example, the control unit 53 operates the movement mechanism 54 and the camera control mechanism 55 in accordance with the result of the information processing by the information processing unit 62.

The information output unit 63 supplies the information provided from the information processing unit 62 to the wireless communication unit 51 and controls the transmission of the supplied information to the information processing apparatus 21.

The movement mechanism 54 operates under the control of the control unit 53 to move the robot 23 by rotating wheels or the like provided on the robot 23.

The camera control mechanism 55 operates under the control of the control unit 53 to control an imaging direction of the camera 56 and the imaging of the subject by the camera 56. The camera 56 functions as an imaging unit that images the task space as the imaging target. That is, the camera 56 images the subject in the task space under the control of the camera control mechanism 55, and supplies an image (moving image) obtained as a result thereof to the control unit 53 or to a recording unit (not illustrated) for recording.

Incidentally, in a case where a subject is imaged by the information processing system 11, a method (hereinafter, referred to as a rail-based method) in which the operator places a travel rail in the task space and the robot 23 travels along the travel rail, and a method (hereinafter, referred to as an autonomous travel method) in which the robot 23 travels autonomously are considered.

For example, in the rail-based method, in the information processing apparatus 21, a region where a subject can be imaged, a subject, an obstacle, and the like are mapped to the configuration space and presented to the operator. Hereinafter, an image of the configuration space in which a region where a subject can be imaged and the like are mapped will be referred to as a configuration space image.

In the configuration space image, a region where a subject can be imaged, the position of a subject, the position of an obstacle, and the like are visualized. In other words, it is visualized which subject can be imaged from which position and posture of the robot 23.

Furthermore, in presenting the configuration space image, a candidate for the travel route of the robot 23 may be obtained on the information processing apparatus 21 side, and the candidate (hereinafter, referred to as a candidate route) may be displayed on the configuration space image. That is, by mapping and visualizing the candidate route on the configuration space, the travel route may be proposed to the operator.

By viewing the presented configuration space image, the operator can visually grasp the position or the like from which the subject can be imaged without inclusion of obstacles in the image and can easily determine (decide) the travel route in which the subject can be smoothly switched as intended. When the operator decides the travel route of the robot 23 while checking the configuration space image, a travel rail for causing the robot 23 to travel along the travel route is placed in the task space.

Here, a specific example of the configuration space image will be described.

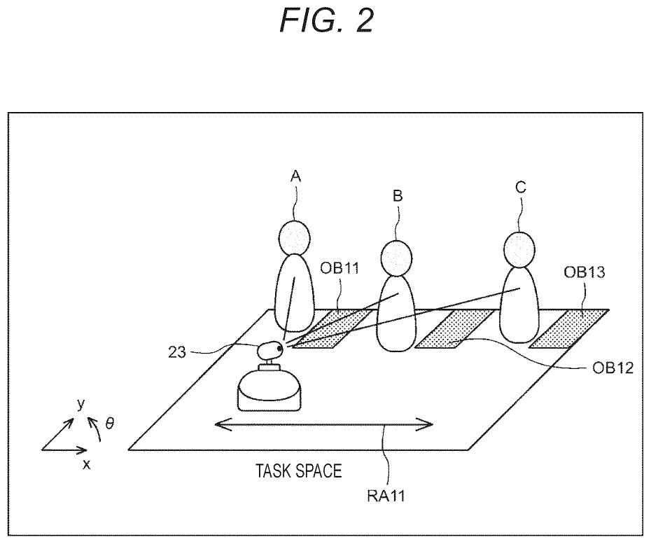

For example, as illustrated in FIG. 2, it is assumed that a subject A, a subject B, and a subject C that are targets, an obstacle OB11, an obstacle OB12, an obstacle OB13, the robot 23, and a travel rail RA11 are arranged in the task space.

Here, a lateral direction in the drawing is defined as an x direction, and a depth direction in the drawing is defined as a y direction, so that the positions of the robot 23 and the like are represented by coordinates (x, y) in an xy-coordinate space. Furthermore, the travel rail RA11, for example, is assumed to be a provisional one.

Moreover, an orientation of the camera 56 of the robot 23 in the horizontal direction in the task space, that is, the imaging direction of the camera 56, is represented by an angle θ.

The configuration space of the robot 23 is a space in which the degrees of freedom of the robot 23 serve as axes. In particular, in this example, the configuration space is a three-dimensional space including an x coordinate (x axis) indicating the position of the robot 23, a y coordinate (y axis) indicating the position of the robot 23, and an angle θ (θ axis) indicating the imaging direction of the robot 23.

One position (point) on the configuration space represents one position and posture of the robot 23 in the task space. Here, the posture refers to the angle θ indicating the imaging direction of the camera 56 of the robot 23.

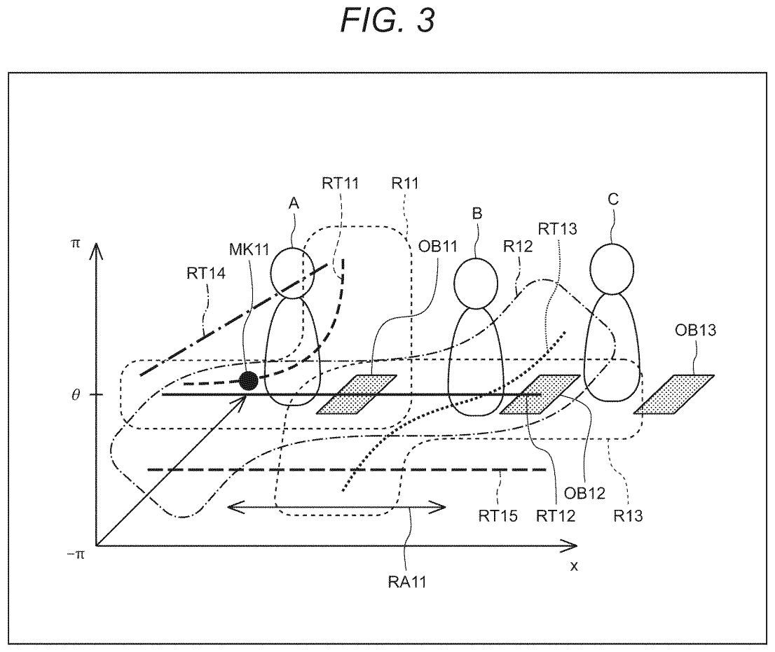

When the subjects A to C, the obstacles OB11 to OB13, and the travel rail RA11 are mapped to such a configuration space, the result appears as illustrated in FIG. 3, for example. Note that, in FIG. 3, portions corresponding to those in the case of FIG. 2 are denoted by the same reference numerals, and the description thereof will be omitted as appropriate.

In the configuration space illustrated in FIG. 3, the lateral direction, the depth direction, and the vertical direction in the drawing correspond to an x-axis direction, a y-axis direction, and a θ-axis direction, respectively.

Furthermore, in the example, a self-position mark MK11 indicating the position and posture of the robot 23, an imageable region R11 to an imageable region R13, and a candidate route RT11 to a candidate route RT15 are mapped (superimposed) to the configuration space.

The self-position mark MK11 is information indicating a position (point) on the configuration space that corresponds to the position (x, y) and posture (angle θ) of the robot 23 in the task space at a predetermined timing, such as the current time point. That is, the self-position mark MK11 is displayed at a position on the configuration space, which is determined by the position (x, y) and posture (angle θ) of the robot 23 at the predetermined timing.

For example, the self-position mark MK11 may be any form, such as an icon representing the robot 23 or an image of the robot 23 itself. By checking the display position of the self-position mark MK11, the operator can grasp the position and posture (imaging direction) of the robot 23.

The imageable region R11 is a three-dimensional region (space) indicating the range of positions and postures of the robot 23 from which the subject A can be imaged. That is, the imageable region R11 is a region in which the robot 23 can image the subject A, in the configuration space.

Accordingly, in a case where the position (point) on the configuration space corresponding to the position and posture of the robot 23 in the task space is within the imageable region R11, the robot 23 can image the subject A.

Similarly, the imageable region R12 is a region indicating the range of positions and postures of the robot 23 from which the subject B can be imaged, and the imageable region R13 is a region indicating the range of positions and postures of the robot 23 from which the subject C can be imaged.

Accordingly, for example, in a case where the position and posture of the robot 23 is the position and posture corresponding to the position (point) within the region where the imageable region R11 to the imageable region R13 overlap, the robot 23 can capture an image in which the subject A to the subject C are included as subjects.

The candidate route RT11 to the candidate route RT15 indicate candidates for the travel route of the robot 23 on the configuration space, calculated by the information processing apparatus 21, for when the robot 23 images one or more subjects while traveling through the task space. That is, the candidate route RT11 to the candidate route RT15 indicate candidates for the travel route proposed by the information processing apparatus 21 to the operator, more specifically, candidates for the travel route and the posture of the robot 23 at each position on the travel route. Each candidate route is calculated on the basis of, for example, a calculation result of the imageable region and the like.

By visually checking which imageable region each candidate route passes through, the operator can easily grasp which subjects will be imaged along each candidate route.

For example, in a case where the robot 23 performs imaging while moving along the candidate route RT11, the state transitions over time from a state where the subject A and the subject B are imaged to a state where only the subject A is imaged. In this case, it can be understood that the imaging can be performed without entering a state where none of the subject A to the subject C is shown as the subject in the image. That is, it can be understood that smooth switching between subjects can be achieved.

In the candidate route RT12, the state transitions from a state where the subject A and the subject B are imaged to a state where the subject A, the subject B, and the subject Care imaged, and thereafter, further transitions to a state where the subject B and the subject C are imaged. In the example, smooth switching between subjects can be achieved.

In the candidate route RT13, the state transitions from a state where the subject C is imaged to a state where the subject B and the subject C are imaged, and thereafter, further transitions to a state where the subject B is imaged. In the example, smooth switching between subjects can be achieved.

On the other hand, in the candidate route RT14, the state transitions from a state where the subject A is imaged to a state where none of the subject A to the subject C is imaged, and thereafter, further transitions to a state where the subject A is imaged again.

Furthermore, in the candidate route RT15, the state transitions from a state where the subject B is imaged to a state where none of the subject A to the subject C is imaged, then transitions to a state where the subject C is imaged, and further transitions to a state where none of the subject A to the subject C is imaged.

In the candidate route RT14 and the candidate route RT15, there are periods during which the target subject is not imaged, that is, periods during which none of the target subjects A to C is included in the image, and thus, it cannot be said that smooth switching between subjects is achieved. Accordingly, such candidate routes RT14 and RT15 require modification or the like as appropriate.

For example, as illustrated in FIG. 3, the information presentation unit 35 displays an image of the configuration space in which subjects, obstacles, the travel rail, the self-position mark, imageable regions, and candidate routes are mapped (displayed), as the configuration space image.

Note that, more specifically, for example, in the configuration space image, an image of a model or the like representing the subject or the obstacle is displayed instead of the subject or the obstacle itself mapped.

Furthermore, for example, in the configuration space image, the operator can edit (modify) the travel route indicated by the travel rail RA11 by performing an operation or the like on the displayed travel rail RA11 (configuration space image). That is, the travel rail RA11 can be edited (modified). Similarly, the candidate route RT11 to the candidate route RT15 can be edited (modified) by performing an operation on the configuration space image.

By generating and presenting the configuration space image as described above, the operator can visually and instantly grasp the position and posture from which the subject can be imaged, the arrangement positions of the subject and the obstacle, and the travel route by the travel rail. Accordingly, the operator can perform route planning of the robot 23 more easily while referring to the configuration space image.

In general, at the time of creating the travel rail, that is, at the time of planning the travel route, the positions of the subject and the robot 23 are visualized on a two-dimensional plane. That is, the route planning is performed with reference to the positions of the subject and the robot 23 arranged on the two-dimensional plane.

However, it is difficult to determine the position and posture of the robot 23 from which a desired subject can be imaged, only with such information on the positional relationship between the subject and the robot 23 on the two-dimensional plane.

In particular, the operator needs to determine the posture of the robot 23 from which a desired subject can be imaged each time, but it is difficult to determine the posture only with the positional relationship on the two-dimensional plane. Furthermore, in a case where there are many subjects (people) and obstacles, or in a case where not only a single imaging point but also the travel route is decided, making a determination becomes even more difficult.

On the other hand, in the information processing system 11, for example, by presenting an image of the configuration space as illustrated in FIG. 3, the travel route of the robot 23 can be planned more easily compared to a case where the route planning is performed on the basis of only the positional relationship on the two-dimensional plane.

In particular, in the example in FIG. 3, the imageable region R11 to the imageable region R13 for each subject are three-dimensional regions that take into account not only the positions of the robot 23 in the x direction and the y direction from which the subject can be imaged, but also the posture (imaging direction) of the robot 23, that is, the angle θ from which the subject can be imaged.

Accordingly, by viewing the imageable region R11 to the imageable region R13, the operator can visually and instantly grasp the position and posture of the robot 23 from which the desired subject can be imaged.

Similarly to the rail-based method in which the operator creates a travel rail as described above, in the autonomous travel method in which the robot 23 autonomously performs route planning, it is possible to perform route planning more easily by using the configuration space image.

In the autonomous travel method, the robot 23 autonomously makes a determination (route planning) and images the subject while autonomously traveling in accordance with the determination.

In this case, for planning the travel route of the robot 23, in addition to the information of the configuration space in which the imageable region and the like are mapped, that is, the above-described configuration space image, behavior policy information supplied from the operator and the like is used.

The behavior policy information is information indicating the behavior policy of the robot 23 regarding the imaging or movement during the imaging, such as which subject is to be imaged and how the robot should travel (move).

For example, as the behavior policy information regarding the imaging, it is possible to designate policies such as imaging as many people together as possible, continuously and without fail capturing the subject A, preventing the subject C from entering (appearing in) the image, and imaging the subject A in the first half and imaging the subject B in the second half.

Furthermore, for example, as the behavior policy information regarding the movement (traveling), it is possible to specify policies such as continuously moving around the stage (task space), and reciprocating in front of the stage.

When such behavior policy information as described above is provided, the robot 23 autonomously decides a travel route for performing the movement (traveling) and imaging in accordance with the behavior policy indicated by the behavior policy information.

In either the above-described rail-based method or autonomous travel method, it is conceivable to display a screen including the configuration space image on the information presentation unit 35 of the information processing apparatus 21.

In this way, the operator can check the positions of the subject and the obstacle, perform route planning, and decide or check the placement position of the rail while viewing the display screen.

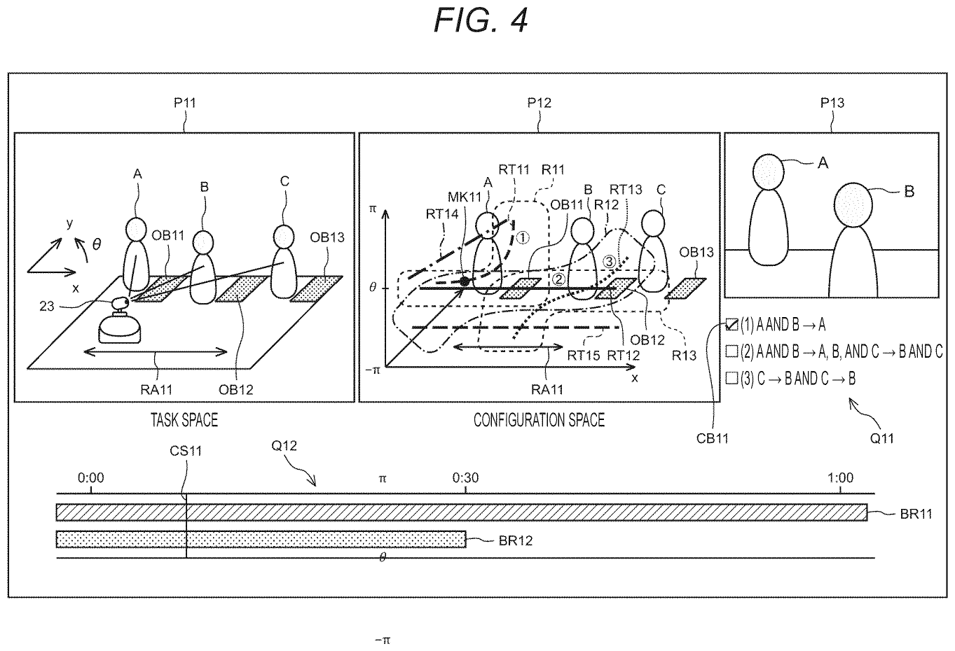

FIG. 4 illustrates an example of a display screen to be displayed on the information presentation unit 35. Note that, in FIG. 4, portions corresponding to those in the case of FIG. 2 or 3 are denoted by the same reference numerals, and the description thereof will be omitted as appropriate.

On the display screen illustrated in FIG. 4, a task space image P11, which is an image of the task space illustrated in FIG. 2, and a configuration space image P12, which is an image of the configuration space illustrated in FIG. 3, are displayed side by side.

The task space image P11 is an image of the task space, which is a general three-dimensional space, that is, a space in an xyz coordinate system, and the subject, the obstacle, the travel rail, and the robot 23 are arranged in the task space. That is, the task space image P11 is an image visually indicating each arrangement position of the subject, the obstacle, the travel rail, and the robot 23.

The configuration space image P12 is an image of the configuration space that is a space in which the degrees of freedom of the robot 23 serve as axes.

In the configuration space image P12, the subject, the obstacle, the travel rail, and the self-position mark of the robot 23 are arranged, and the imageable regions of each subject and multiple candidate routes are also displayed.

The operator can edit (modify) the travel rail or the candidate routes by, for example, operating the information input unit 31 to perform an operation or the like on the task space image P11 or the configuration space image P12 on the display screen, particularly an operation or the like on portions of the travel rail or the candidate routes. That is, the operator can change the travel route of the robot 23 indicated by the travel rail or the candidate route by editing (modifying) the travel rail or the candidate route.

On the display screen, a simulated capture image P13 is displayed on the right side of the configuration space image P12.

The simulated capture image P13 is an image which is generated, for example, by simulation based on the positions of the subject and the like and the position and posture of the robot 23, and would be obtained through imaging when the robot 23 is at the position and posture indicated by the self-position mark. That is, the simulated capture image P13 is a simulation image corresponding to an image that would be captured by the robot 23.

Furthermore, candidate routes proposed by the information processing apparatus 21 and checkboxes for selecting the candidate route are displayed in a list in a portion indicated by an arrow Q11 below the simulated capture image P13. That is, a list of candidate routes (candidate route list) is displayed. Note that a plurality of candidate routes may be displayed, or only one candidate route may be displayed.

In this example, the candidate route RT11 to the candidate route RT13 are presented as candidates for the travel route. Furthermore, a check mark is displayed in a checkbox CB11, and thus the candidate route RT11 corresponding to the checkbox CB11 is in a selected state. Therefore, an image that would be obtained when the robot 23 travels (moves) along the candidate route RT11 is displayed as the simulated capture image P13.

Moreover, a timeline indicating a section during which one or more subjects is imaged, which is obtained by the information processing unit 33 on the basis of the imageable region and the like, is displayed in a portion indicated by an arrow Q12 on the display screen.

In particular, a display bar BR11 in the timeline indicates a section (time instant) during which the subject A is imaged, and a display bar BR12 indicates a section (time instant) during which the subject B is imaged.

In this example, since the candidate route RT11 is selected via the checkbox CB11, the display bars are displayed for the subject A and the subject B, which would be imaged as the subjects when the robot 23 performs imaging along the candidate route RT11.

Furthermore, the operator can move a cursor CS11 on the timeline as appropriate. On the display screen, the task space image P11, the configuration space image P12, and the simulated capture image P13 are changed according to the position of the cursor CS11, that is, according to the time instant indicated by the cursor CS11.

Specifically, in the task space, the position of the subject and the position and posture of the robot 23 may be changed over time (time instants). Furthermore, the position of the obstacle may also be changed over time. Moreover, when the position of the subject or obstacle is changed, the imageable region is also changed over time.

Therefore, in the task space image P11 and the configuration space image P12, the position of the subject or the obstacle, the position and posture of the robot 23 (the position of the self-position mark), and the imageable region are changed according to the position of the cursor CS11. Then, the simulated capture image P13 is also changed in accordance with the changes in the task space image P11 and the configuration space image P12.

The operator can easily grasp how the subject or the obstacle, the position and posture of the robot 23, the imageable region, and the simulated capture image P13 are changed over time. In particular, the operator can visually grasp what kind of image will actually be captured by viewing the simulated capture image P13.

### Description of Map Generation Processing and Preliminary Preparation Processing

Next, the operation of the information processing system 11 will be described. Note that the processing described below is merely an example, and each kind of processing may be performed by any apparatus constituting the information processing system 11.

First, the operation in the rail-based method will be described.

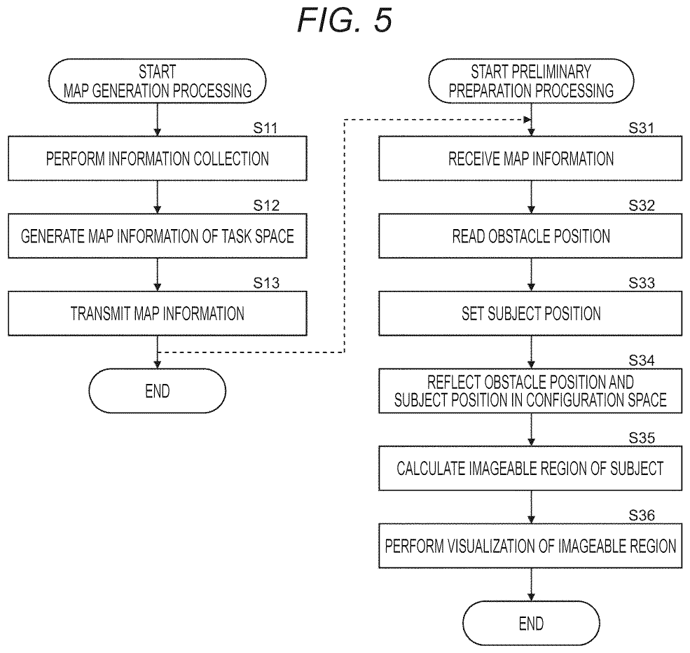

In the rail-based method, before placing the travel rail, processing illustrated in FIG. 5 is performed, and the imageable regions are visualized. Hereinafter, with reference to the flowchart in FIG. 5, the map generation processing by the robot 23 and the preliminary preparation processing by the information processing apparatus 21 will be described.

When the robot 23 is arranged in the task space, the map generation processing is started. In this case, it is assumed that at least an obstacle is present in the task space, and the target subject may be or may not be arranged in the task space.

In step S11, the information acquisition unit 61 of the robot 23 collects information for generating map information indicating the task space.

For example, the operator operates the information processing apparatus 21 as appropriate to cause the robot 23 to travel in the task space. While the robot 23 is traveling in the task space, the information acquisition unit 61 uses the sensor 52, the wireless communication unit 51, and the camera 56 to collect information required for generating the map information, and supplies the collected information to the information processing unit 62.

For example, the information acquisition unit 61 collects, as the information required for generating the map information, detection results of the position of the obstacle and the position of the subject obtained by the sensor 52, images captured by the camera 56, a detection result of the position of the subject received from the environment-installed sensor 22 via the wireless communication unit 51, and the like.

In step S12, the information processing unit 62 generates map information of the task space on the basis of the information collected in step S11 and supplied from the information acquisition unit 61.

Therefore, the map information of the task space is obtained, indicating the shape of the task space and the position, size, and shape of the obstacle present in the task space. Note that in a case where a subject is arranged in the task space, information such as the position of the subject can also be obtained from the map information.

The information processing unit 62 supplies the generated map information to the wireless communication unit 51 via the information output unit 63, and instructs transmission of the map information to the information processing apparatus 21.

In step S13, the wireless communication unit 51 transmits the map information supplied from the information output unit 63 to the information processing apparatus 21.

When the map information is transmitted, the map generation processing ends. Note that even after the map generation processing ends, the robot 23 may travel in the task space as appropriate and transmit information indicating the position of the subject in the task space or the like to the information processing apparatus 21. In this case, the information indicating the position of the subject is obtained (acquired), for example, by the environment-installed sensor 22 or the sensor 52.

When the processing of step S13 is performed and the map information is transmitted, the preliminary preparation processing is started in the information processing apparatus 21.

In step S31, the information acquisition unit 32 receives the map information transmitted from the robot 23, and supplies the map information to the information processing unit 33.

In step S32, the information processing unit 33 reads in the obstacle position in the task space on the basis of the map information supplied from the information acquisition unit 32.

For example, since the map information includes information regarding the position of the obstacle in the task space, the information processing unit 33 extracts (reads) information regarding the position of the obstacle from the map information, and uses the information as obstacle position information.

In step S33, the information processing unit 33 sets a subject position in the task space.

For example, in a case where the map information already includes information regarding the position of the subject, the information processing unit 33 extracts (reads) information regarding the position of the subject from the map information, and uses the information as subject position information.

Furthermore, in a case where the map information does not include information regarding the position of the subject, the information processing unit 33 generates subject position information indicating the position of each subject on the basis of the information regarding the position of one or more subjects in the task space, which is acquired by the information acquisition unit 32.

In this case, for example, when the operator operates the information input unit 31 to input the position of each subject, the information acquisition unit 32 acquires, as information regarding the positions of the subjects, signals output from the information input unit 31 in response to the operation. Furthermore, for example, in a case where the information regarding the position of the subject is transmitted from the robot 23, the information acquisition unit 32 also acquires information regarding the subject by receiving the information.

The information processing unit 33 sets the subject position by arranging the subject at the position in the task space indicated by the subject position information obtained in this manner.

In step S34, the information processing unit 33 reflects the obstacle position and the subject position in the task space, in the configuration space.

That is, the information processing unit 33 maps (arranges) the obstacle and the subject in the task space to the configuration space on the basis of the obstacle position information and the subject position information obtained in steps S32 and S33.

Note that, in a case where the coordinate system regarding the position is different between the task space and the configuration space, coordinate transformation is performed, and then mapping is performed. In the following description, it is assumed that the coordinate systems regarding the positions of the task space and the configuration space are the same.

In step S35, the information processing unit 33 calculates the imageable region of the subject in the configuration space on the basis of a mapping result of the subject and the obstacle to the configuration space, in other words, on the basis of the position of each subject and the position of each obstacle in the task space.

That is, in step S35, a three-dimensional region is calculated for each subject, the three-dimensional region including positions (points) in the configuration space corresponding to the position (x, y) in the task space from which the robot 23 can image the subject and the posture (angle θ) of the robot 23 at that position.

For example, the position and posture from which a subject can be imaged refers to the position and posture from which an image that includes the target subject and does not include the obstacle can be obtained when the camera 56 performs imaging.

Note that the position and posture from which the subject can be imaged may be any position and posture as long as the position and posture satisfy predetermined conditions regarding the subject and the obstacle, such as ensuring that neither any part nor the entirety of the subject is hidden by the obstacle in the captured image.

By the processing in step S35, for example, the imageable region R11 to the imageable region R13 illustrated in FIG. 3 are obtained by calculation.

In step S36, the information processing unit 33 visualizes the imageable region for each subject obtained in step S35.

Specifically, for example, the information processing unit 33 generates display data (image data) for the display screen on which the image of the configuration space to which each subject, the obstacle, and the imageable region of each subject are mapped is to be displayed, and supplies the display data to the information presentation unit 35 to display the display screen. The display data, particularly the configuration space image and the task space image, are generated, for example, on the basis of the subject position and the obstacle position in the task space, the calculation result of the imageable region, the map information, and the like.

Therefore, for example, a screen similar to the display screen illustrated in FIG. 4 is displayed on the information presentation unit 35. However, in the display screen displayed in step S36, the travel rail is not displayed in the task space image, and the travel rail and the candidate route are not displayed in the configuration space image.

That is, in the task space image, the subject and the obstacle are displayed, and the travel rail and the robot 23 are not displayed. Note that, in the task space image, the travel rail and the robot 23 may be arranged and displayed at temporary positions such as predetermined positions.

Similarly, in the configuration space image, the subject and the obstacle, that is, the position of the subject and the position of the obstacle, as well as the imageable region for each subject are displayed, and the self-position mark, the travel rail, and the candidate route are not displayed. Note that, in the configuration space image, the self-position mark and the travel rail may be arranged and displayed at temporary positions such as predetermined positions.

When the configuration space image is displayed and the imageable regions are visualized, the preliminary preparation processing ends.

As described above, the robot 23 generates the map information of the task space and transmits the map information to the information processing apparatus 21. Furthermore, the information processing apparatus 21, upon receiving the supply of the map information from the robot 23, calculates the imageable regions and visualizes the imageable regions for presentation to the operator.

In this manner, the operator can visually and instantly grasp which subject can be imaged from which position and posture by viewing the configuration space image. Therefore, the operator can more easily plan the travel route of the robot 23.

### Description of Travel Preparation Processing and Travel Processing

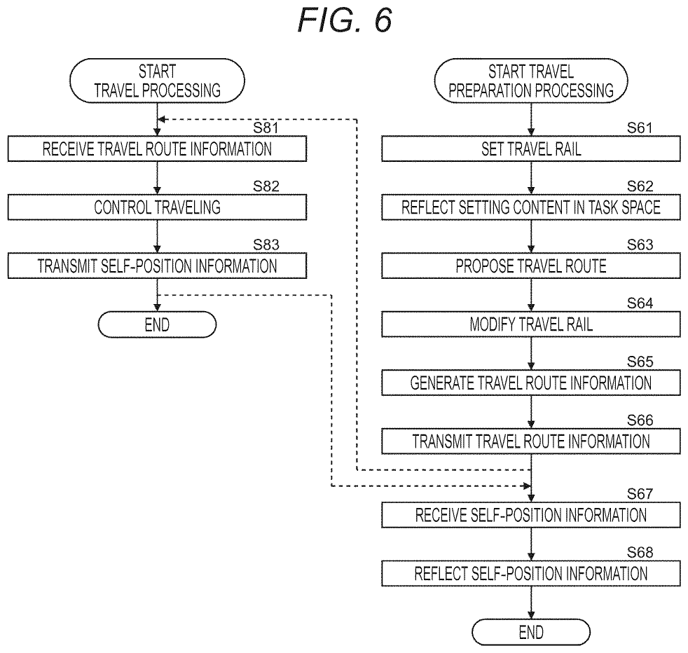

Furthermore, when the map generation processing and the preliminary preparation processing illustrated in FIG. 5 have been performed and a display screen including the configuration space image is displayed on the information presentation unit 35, the processing illustrated in FIG. 6 is subsequently performed. Hereinafter, referring to the flowchart in FIG. 6, the travel preparation processing by the information processing apparatus 21 and the travel processing by the robot 23 will be described.

When the travel preparation processing is started, in step S61, the information processing unit 33 sets a travel rail on the basis of the signal supplied from the information input unit 31 via the information acquisition unit 32, in accordance with the operation by the operator.

For example, when the display screen including the task space image and the configuration space image is displayed on the information presentation unit 35, the operator operates the information input unit 31 to perform an operation on the display screen, thereby placing a temporary travel rail on the configuration space image. In this case, for example, a screen similar to the display screen illustrated in FIG. 4 is displayed as the display screen, and the self-position mark is also appropriately displayed in the configuration space image on the display screen. Note that, at this time point, no travel rail is displayed in the task space image.

When the temporary travel rail is displayed in the configuration space image, the operator checks the temporary travel rail and further operates the information input unit 31 to appropriately change the placement position (arrangement position), length, and the like of the temporary travel rail, that is, the route of the travel rail.

The information processing unit 33, in response to the signal supplied from the information input unit 31 via the information acquisition unit 32, controls the information presentation unit 35 to change the position and the like of the travel rail in the configuration space image, thereby setting the travel rail.

Once the travel rail has been set, the information processing unit 33 reflects the setting contents made in step S61 in the task space in step S62.

That is, the information processing unit 33 maps (arranges) the travel rail set in the configuration space in step S61 to the task space.

Therefore, the travel rail is displayed also in the task space image on the display screen presented on the information presentation unit 35, at the same position as in the case of the configuration space image.

In step S63, the information processing unit 33 proposes travel routes.

For example, the information processing unit 33 calculates candidate routes on the basis of the positions of the subject and the obstacle, the imageable region for each subject, and the arrangement position and the route of the travel rail. The calculation of the candidate route may also use, as appropriate, behavior policy information input by the operator.

When the candidate route is calculated, the information processing unit 33 controls the information presentation unit 35 according to the calculation result to update the display of the display screen. That is, the information processing unit 33 proposes the travel route of the robot 23 to the operator by displaying a list of the candidate routes on the display screen or by displaying one or more candidate routes in the configuration space image.

Then, the operator can check the arrangement position and the like of the travel rail while viewing the display screen, or operate the information input unit 31 to modify the arrangement position and the like of the travel rail. In this case, the operator can select the presented candidate route, appropriately modify the selected candidate route, and adopt the modified candidate route as the final travel route of the robot 23, as indicated by the travel rail.

In step S64, the information processing unit 33 modifies the travel rail on the basis of the signal supplied from the information input unit 31 via the information acquisition unit 32, in response to an input operation by the operator. In other words, the final travel route of the robot 23 is decided in accordance with the input operation by the operator.

In step S65, the information processing unit 33 generates travel route information indicating the travel route of the robot 23 along the travel rail on the basis of the arrangement position of the finally decided travel rail, and supplies the travel route information to the information output unit 34.

Note that, more specifically, the travel route information includes, in addition to the information indicating the travel route of the robot 23, speed information and posture information (angle θ) for each section of the travel route, such as the speed and posture at which the robot 23 travels along the travel route.

In step S66, the information output unit 34 transmits the travel route information supplied from the information processing unit 33 to the robot 23. Furthermore, in the task space, the actual travel rail is placed as appropriate.

Then, in the robot 23, the travel processing is started.

That is, in step S81, the wireless communication unit 51 of the robot 23 receives the travel route information transmitted from the information processing apparatus 21, and supplies the travel route information to the information processing unit 62 via the information acquisition unit 61.

In step S82, the information processing unit 62 controls the travel of the robot 23 on the basis of the travel route information supplied from the information acquisition unit 61.

Specifically, for example, the information processing unit 62 controls the movement mechanism 54 to cause the robot 23 to travel while specifying the position and posture of the robot 23 on the basis of the travel route information, the map information generated in step S12 in FIG. 5, and, as appropriate, the information supplied from the information acquisition unit 61.

Therefore, the robot 23 travels along the travel route indicated by the travel route information, at the speed and orientation (angle θ) indicated by the travel route information. At this time, the information processing unit 62 (control unit 53) may also control the camera control mechanism 55 as appropriate, on the basis of the travel route information, to cause the camera 56 to perform imaging.

Note that the information supplied from the information acquisition unit 61 during the travel control of the robot 23 may include, for example, the detection result of the subject position obtained by the environment-installed sensor 22, the detection result of the position of the subject or the obstacle obtained by the sensor 52, and the image (video) obtained by imaging with the camera 56. The information processing unit 62 estimates (specifies) the position and posture of the robot 23 on the basis of the detection result of the position of the subject or the obstacle, the image of the task space captured by the camera 56, the map information, the travel route information, and the like.

Furthermore, at each time instant during the travel of the robot 23, the information processing unit 62 generates self-position information indicating the position and posture of the robot 23 for each time instant, and supplies the self-position information to the wireless communication unit 51 via the information output unit 63.

In step S83, the wireless communication unit 51 transmits the self-position information supplied from the information output unit 63 to the information processing apparatus 21, and the travel processing ends. Note that the transmission of the self-position information is sequentially performed until the travel of the robot 23 ends.

Furthermore, when the self-position information is transmitted, the information processing apparatus 21 executes the processing in step S67.

That is, in step S67, the information acquisition unit 32 receives the self-position information transmitted from the robot 23 through the processing in step S83, and supplies the self-position information to the information processing unit 33.

In step S68, the information processing unit 33 reflects the self-position information supplied from the information acquisition unit 32, in the task space image and the configuration space image displayed on the information presentation unit 35.

For example, when the travel of the robot 23 is started, the information processing unit 33 causes the information presentation unit 35 to display a screen similar to the display screen illustrated in FIG. 4.

In this case, when the self-position information at each time instant is received from the robot 23, the information processing unit 33 generates the task space image in which the position and posture of the robot 23 correspond to the position and posture indicated by the received self-position information, and causes the task space image to be displayed on the display screen.

Similarly, the information processing unit 33 generates the configuration space image in which the self-position mark in the configuration space is displayed at a position corresponding to the position and posture indicated by the received self-position information, and causes the configuration space image to be displayed on the display screen.

Therefore, the received self-position information of the robot 23 is reflected in both the task space image and the configuration space image.

Furthermore, the information processing unit 33 generates a simulated capture image by simulation on the basis of the travel route information and the configuration space image in which the self-position information is reflected, that is, the information of the configuration space to which the subject, the obstacle, and the like are mapped, and causes the simulated capture image to be displayed on the display screen. Therefore, the operator can easily grasp the image to be captured by the robot 23. Note that, during the travel of the robot 23, the image actually captured by the robot 23 may be displayed in place of the simulated capture image.

The information processing unit 33 continuously performs the processing in step S68 until the travel of the robot 23 ends, and when the travel of the robot 23 ends, the travel preparation processing ends.

As described above, the information processing apparatus 21 causes the display screen including the task space image and the configuration space image to be displayed, performs the setting of the travel rail and the generation of the travel route information in response to the operation by the operator, and reflects the self-position information of the robot 23 during travel, on the display screen. Furthermore, the robot 23, upon receiving the supply of the travel route information from the information processing apparatus 21, travels on the basis of the travel route information and transmits the self-position information to the information processing apparatus 21.

In this manner, by presenting the configuration space image to the operator, the operator can more easily plan the travel route of the robot 23.

Meanwhile, even in the autonomous travel method in which the robot 23 autonomously performs the route planning, the information processing system 11 performs the map generation processing and the preliminary preparation processing described with reference to FIG. 5.

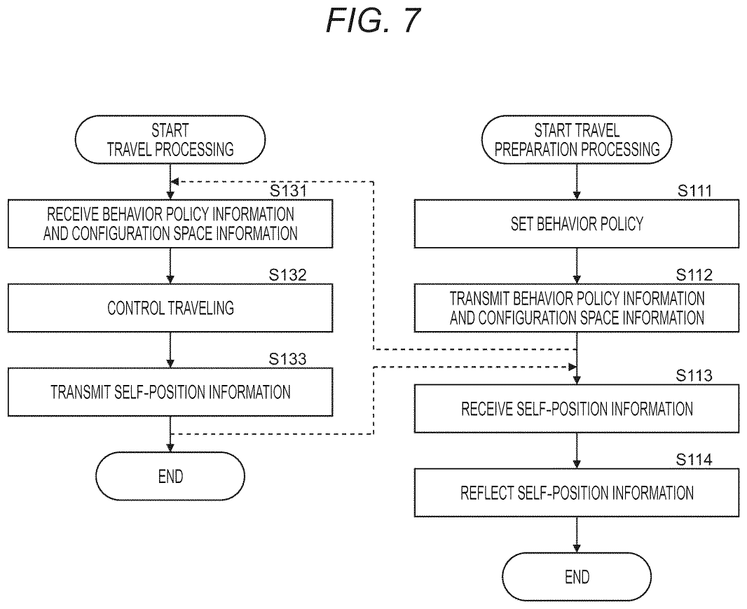

Furthermore, in the autonomous travel method, once the preliminary preparation processing is performed, the information processing system 11 subsequently performs the travel preparation processing and the travel processing illustrated in FIG. 7.

Hereinafter, referring to the flowchart in FIG. 7, the travel preparation processing by the information processing apparatus 21 and the travel processing by the robot 23 will be described.

When the travel preparation processing is started in the information processing apparatus 21, in step S111, the information processing unit 33 sets a behavior policy on the basis of the signal supplied from the information input unit 31 via the information acquisition unit 32, in accordance with the operation by the operator.

For example, the information presentation unit 35 displays the display screen including the task space image and the configuration space image. Note that, in this case, the travel rail is not displayed in the task space image and the configuration space image. Furthermore, no candidate route is displayed in the configuration space image.

The operator appropriately operates the information input unit 31 while viewing the display screen to input the behavior policy of the robot 23 during imaging, such as which subject is to be imaged or how the robot should travel. Then, the information processing unit 33 generates behavior policy information indicating the behavior policy input by the operator, according to the signal supplied from the information input unit 31 via the information acquisition unit 32.

Furthermore, the information processing unit 33 generates configuration space information indicating the positions of the subject and the obstacle and the imageable region in the configuration space, on the basis of the configuration space image and the like. The configuration space information is information regarding the configuration space, and the configuration space information at least includes information indicating the imageable region.

The information processing unit 33 supplies the behavior policy information and the configuration space information to the information output unit 34, and instructs the transmission thereof to the robot 23.

In step S112, the information output unit 34 transmits the behavior policy information and the configuration space information supplied from the information processing unit 33, to the robot 23.

When the behavior policy information and the configuration space information are transmitted, the travel processing is started in the robot 23, and the processing of step S131 is performed.

In step S131, the wireless communication unit 51 receives the behavior policy information and the configuration space information transmitted from the information processing apparatus 21, and supplies the behavior policy information and the configuration space information to the information processing unit 62 via the information acquisition unit 61.

In step S132, the information processing unit 62 controls the travel of the robot 23 on the basis of the behavior policy information and the configuration space information supplied from the information acquisition unit 61.

Specifically, for example, the information processing unit 62 controls the movement mechanism 54 on the basis of the behavior policy information and the configuration space information, the map information generated in step S12 in FIG. 5, and, as appropriate, the information supplied from the information acquisition unit 61, to cause the robot 23 to autonomously travel.

At this time, the information supplied from the information acquisition unit 61 to the information processing unit 62 may include, for example, the detection result of the subject position obtained by the environment-installed sensor 22, the detection result of the position of the subject or the obstacle obtained by the sensor 52, and the image (video) obtained by imaging with the camera 56.

The information processing unit 62 specifies (estimates) the position and posture of the robot 23 on the basis of the behavior policy information, the configuration space information, the map information, and the like, and autonomously decides the travel route in accordance with the behavior policy indicated by the behavior policy information.

The information processing unit 62 controls the movement mechanism 54 to cause the robot 23 to travel along the decided travel route, and also controls the camera control mechanism 55 as appropriate to cause the camera 56 to perform imaging. Therefore, the robot 23 performs traveling and imaging while autonomously deciding its own travel route.

Furthermore, similarly to the case of step S82 in FIG. 6, the information processing unit 62 generates self-position information indicating the position and posture of the robot 23 at each time instant during travel, and supplies the self-position information to the wireless communication unit 51 via the information output unit 63.

In step S133, the wireless communication unit 51 transmits the self-position information supplied from the information output unit 63 to the information processing apparatus 21, and the travel processing ends. Note that the transmission of the self-position information is sequentially performed until the travel of the robot 23 ends.

When the processing in step S133 is performed, the processing in steps S113 and S114 is subsequently performed in the information processing apparatus 21, and the travel preparation processing ends. Note that the processing in steps S113 and S114 is similar to the processing in steps S67 and S68 in FIG. 6, and thus the detailed description thereof will be omitted.

As described above, the information processing apparatus 21 transmits the behavior policy information and the configuration space information to the robot 23. Furthermore, the robot 23 autonomously decides the travel route on the basis of the behavior policy information and the configuration space information, and travels.

As described above, by supplying the behavior policy information and the configuration space information to the robot 23, the robot 23 can autonomously decide an appropriate travel route more easily. That is, the travel route can be planned more easily.

### Configuration Example of Computer

Incidentally, the above-described series of processing can be executed by hardware or software. In a case where a series of processing is executed by the software, a program constituting the software is installed in a computer. Here, examples of the computer include a computer incorporated in dedicated hardware, and for example, a general-purpose personal computer capable of executing various functions by installing various programs or the like.

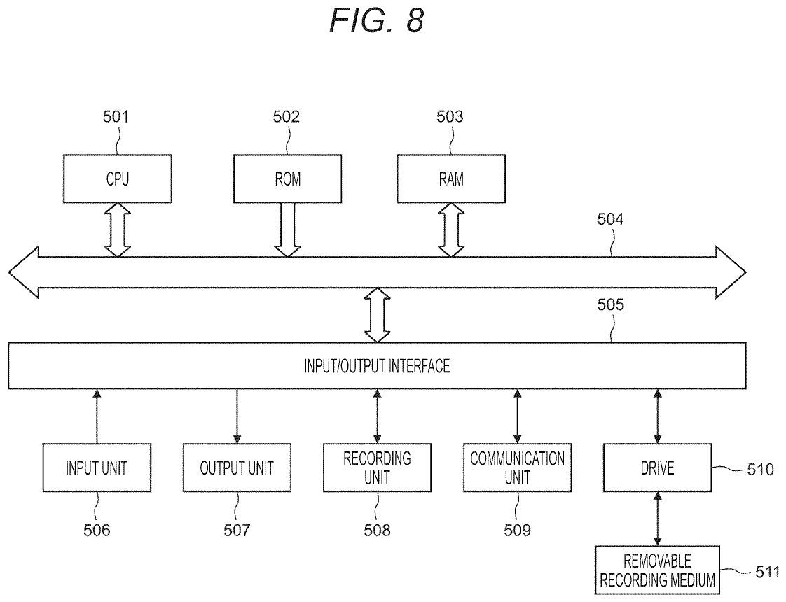

FIG. 8 is a block diagram illustrating a configuration example of hardware of a computer that executes the above-described series of processing by a program.

In the computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an imaging device, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program so that the above-described series of processing is performed.

The program executed by the computer (CPU 501) can be provided by being recorded on the removable recording medium 511 as a package medium and the like, for example. Furthermore, the program can be provided via a wired or wireless transmission medium such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed in the recording unit 508. In addition, the program can be installed in the ROM 502 or the recording unit 508 in advance.

Note that the program executed by the computer may be a program in which processing is performed in time series in the order described in the present specification, or may be a program in which processing is performed in parallel or at necessary timing such as when a call is made.

Furthermore, the embodiments of the present technology are not limited to the above-described embodiments, and various modifications are possible without departing from the scope of the present technology.

For example, the present technology can have a configuration of cloud computing in which one function is shared and processed in cooperation by a plurality of apparatuses via a network.

Furthermore, each step described in the flowchart described above can be performed by one apparatus or can be shared and performed by a plurality of apparatuses.

Moreover, in a case where a single step includes a plurality of pieces of processing, the plurality of pieces of processing included in the single step can be performed by a single apparatus or shared and performed by a plurality of apparatuses.

Moreover, the present technology may also have following configurations.
(1)

An information processing method including:
a step of causing an information processing system to execute
calculating, on a basis of a position of one or more subjects in a task space, an imageable region where a robot that images the subject is capable of imaging the subject in a configuration space of the robot; and
displaying an image of the configuration space in which the imageable region is displayed.
(2)

The information processing method according to (1),
in which the imageable region is calculated for each subject.
(3)

The information processing method according to (1) or (2),
in which an image of the configuration space in which the position of the subject and the imageable region are displayed is displayed.
(4)

The information processing method according to any one of (1) to (3),
in which an image of the configuration space in which a position of an obstacle in the task space and the imageable region are displayed is displayed.
(5)

The information processing method according to any one of (1) to (4),
in which a candidate for a route of the robot in the configuration space when the robot images the one or more subjects while traveling in the task space is calculated on a basis of the imageable region, and
an image of the configuration space in which the candidate for the route and the imageable region are displayed is displayed.
(6)

The information processing method according to (5),
in which a list of one or more candidates is further displayed.
(7)

The information processing method according to (5) or (6),
in which the candidate is capable of being modified by an operation on the image.
(8)

The information processing method according to any one of (1) to (7),
in which an image of the configuration space in which information indicating a position in the configuration space corresponding to a position and a posture of the robot at a predetermined timing and the imageable region are displayed is displayed.
(9)

The information processing method according to any one of (1) to (8),
in which an image of the configuration space in which a travel rail of the robot and the imageable region are displayed is displayed.
(10)

The information processing method according to (9),
in which the travel rail is capable of being modified by an operation on the image.
(11)

The information processing method according to any one of (1) to (10),
in which an image of the task space in which the subject is arranged is further displayed.
(12)

The information processing method according to any one of (1) to (11),
in which an image to be captured by the robot is generated by simulation on a basis of a position and a posture of the robot, and the image generated by the simulation is further displayed.
(13)

The information processing method according to any one of (1) to (12),
in which a timeline indicating a section during which the one or more subjects is imaged is further displayed on a basis of the imageable region.
(14)

The information processing method according to any one of (1) to (13),
in which a travel route of the robot is decided according to an operation by an operator, and travel route information indicating the decided travel route is transmitted to the robot.
(15)

The information processing method according to any one of (1) to (13),
in which behavior policy information indicating a behavior policy of the robot regarding imaging and traveling is generated according to an operation by an operator, and
the behavior policy information and the information regarding the configuration space including information indicating the imageable region are transmitted to the robot.
(16)

An information processing apparatus including:
an information processing unit that calculates, on a basis of a position of one or more subjects in a task space, an imageable region where a robot that images the subject is capable of imaging the subject in a configuration space of the robot, and displays an image of the configuration space in which the imageable region is displayed.
(17)

A program causing a computer to execute processing including:
a step of calculating, on a basis of a position of one or more subjects in a task space, an imageable region where a robot that images the subject is capable of imaging the subject in a configuration space of the robot; and
a step of displaying an image of the configuration space in which the imageable region is displayed.

### REFERENCE SIGNS LIST

11 Information processing system
21 Information processing apparatus
22 Environment-installed sensor
23 Robot
31 Information input unit
32 Information acquisition unit
33 Information processing unit
34 Information output unit
35 Information presentation unit
51 Wireless communication unit
52 Sensor
53 Control unit
54 Movement mechanism
55 Camera control mechanism
56 Camera
61 Information acquisition unit
62 Information processing unit
63 Information output unit

1. An information processing method comprising:
a step of causing an information processing system to execute
calculating, on a basis of a position of one or more subjects in a task space, an imageable region where a robot that images the subject is capable of imaging the subject in a configuration space of the robot; and
displaying an image of the configuration space in which the imageable region is displayed.

2. The information processing method according to claim 1,
wherein the imageable region is calculated for each subject.

3. The information processing method according to claim 1,
wherein an image of the configuration space in which the position of the subject and the imageable region are displayed is displayed.

4. The information processing method according to claim 1,
wherein an image of the configuration space in which a position of an obstacle in the task space and the imageable region are displayed is displayed.

5. The information processing method according to claim 1,
wherein a candidate for a route of the robot in the configuration space when the robot images the one or more subjects while traveling in the task space is calculated on a basis of the imageable region, and
an image of the configuration space in which the candidate for the route and the imageable region are displayed is displayed.

6. The information processing method according to claim 5,
wherein a list of one or more candidates is further displayed.

7. The information processing method according to claim 5,
wherein the candidate is capable of being modified by an operation on the image.

8. The information processing method according to claim 1,
wherein an image of the configuration space in which information indicating a position in the configuration space corresponding to a position and a posture of the robot at a predetermined timing and the imageable region are displayed is displayed.

9. The information processing method according to claim 1,
wherein an image of the configuration space in which a travel rail of the robot and the imageable region are displayed is displayed.

10. The information processing method according to claim 9,
wherein the travel rail is capable of being modified by an operation on the image.

11. The information processing method according to claim 1,
wherein an image of the task space in which the subject is arranged is further displayed.

12. The information processing method according to claim 1,
wherein an image to be captured by the robot is generated by simulation on a basis of a position and a posture of the robot, and the image generated by the simulation is further displayed.

13. The information processing method according to claim 1,
wherein a timeline indicating a section during which the one or more subjects is imaged is further displayed on a basis of the imageable region.

14. The information processing method according to claim 1,
wherein a travel route of the robot is decided according to an operation by an operator, and travel route information indicating the decided travel route is transmitted to the robot.

15. The information processing method according to claim 1,
wherein behavior policy information indicating a behavior policy of the robot regarding imaging and traveling is generated according to an operation by an operator, and
the behavior policy information and the information regarding the configuration space including information indicating the imageable region are transmitted to the robot.

16. An information processing apparatus comprising:
an information processing unit that calculates, on a basis of a position of one or more subjects in a task space, an imageable region where a robot that images the subject is capable of imaging the subject in a configuration space of the robot, and displays an image of the configuration space in which the imageable region is displayed.

17. A program causing a computer to execute processing comprising:
a step of calculating, on a basis of a position of one or more subjects in a task space, an imageable region where a robot that images the subject is capable of imaging the subject in a configuration space of the robot; and
a step of displaying an image of the configuration space in which the imageable region is displayed.
